(19) United States
(12) Patent Application Publication
(10) Pub. No.: US 2023/0268557 A1
(43) Pub. Date: Aug. 24, 2023

(54) NON-AQUEOUS ELECTROLYTIC SOLUTION SECONDARY BATTERY AND METHOD FOR PRODUCING NON- AQUEOUS ELECTROLYTIC SOLUTION SECONDARY BATTERY

(71) Applicant: SANYO Electric Co., Ltd., Kadoma-shi, Osaka (JP)

(72) Inventors: Yasuyuki Takai, Osaka (JP); Atsushi Kaiduka, Osaka (JP)

(73) Assignee: SANYO Electric Co., Ltd., Kadoma-shi, Osaka (JP)

(21) Appl. No.: 18/017,957

(22) PCT Filed: Jul. 8, 2021
(86) PCT No.: PCT/JP2021/025721

§ 371 Date: Jan. 25, 2023

(30) Foreign Application Priority Data
Jul. 30, 2020 (JP) 2020-129299

(51) Int. Cl. H01M 10/0587; H01M 50/107; H01M 50/46; H01M 50/124

(52) U.S. Cl. CPC H01M 10/0587; H01M 50/107; H01M 50/1243; H01M 50/46

(57) ABSTRACT

The present disclosure provides a non-aqueous electrolytic solution secondary battery capable of suppressing increase of initial resistance when an isocyanate group-containing compound is added to a non-aqueous electrolytic solution. The non-aqueous electrolytic solution secondary battery according to one embodiment of the present disclosure has: a wound type electrode body in which a positive electrode and a negative electrode are wound with a separator interposed therebetween; and a battery case for housing the wound type electrode body and the non-aqueous electrolytic solution. The relation between a nitrogen element concentration A1 derived from an isocyanate group-containing compound in an outermost circumferential surface 2a of the wound type electrode body, and a nitrogen element concentration B derived from an isocyanate group-containing compound in an inner region located further in than the outermost circumferential surface of the wound type electrode body, satisfies A1>B.

### TECHNICAL FIELD

The present disclosure relates to a non-aqueous electrolyte secondary battery and a method for manufacturing a non-aqueous electrolyte secondary battery.

### BACKGROUND

In recent years, as secondary batteries with a high output and a high energy density, non-aqueous electrolyte secondary batteries are widely used that include a positive electrode, a negative electrode, and a non-aqueous electrolyte and perform charge and discharge by allowing lithium ions or the like to travel between the positive electrode and the negative electrode.

For example, Patent Literature 1 proposes a non-aqueous electrolyte secondary battery using a non-aqueous electrolyte to which a diisocyanate compound is added. Patent Literature 1 shows that using the non-aqueous electrolyte to which the diisocyanate compound is added reduces the amount of a gas generated during high-temperature storage, and thus reduces the amount of swelling of a battery and suppresses deterioration of charge-discharge cycle characteristics.

### CITATION LIST

### Patent Literature

Patent Literature 1:JP 2007-242411 A

### SUMMARY

### Technical Problem

Adding an isocyanate group-containing compound to a non-aqueous electrolyte can suppress deterioration of charge-discharge cycle characteristics of a battery, but has a problem of an increase in the initial resistance of the battery.

Therefore, an object of the present disclosure is to provide a non-aqueous electrolyte secondary battery in which an increase in the initial resistance can be suppressed in the case of adding an isocyanate group-containing compound to a non-aqueous electrolyte, and to provide a method for manufacturing the non-aqueous electrolyte secondary battery.

### Solution to Problem

A non-aqueous electrolyte secondary battery of an aspect of the present disclosure includes a wound electrode assembly including a positive electrode, a negative electrode, and a separator in which the positive electrode and the negative electrode are wound with the separator interposed between the positive electrode and the negative electrode, a non-aqueous electrolyte, and a battery case housing the wound electrode assembly and the non-aqueous electrolyte, and a nitrogen element concentration Al derived from an isocyanate group-containing compound in an outermost peripheral surface of the wound electrode assembly and a nitrogen element concentration B derived from an isocyanate group-containing compound in an inner region inside the outermost peripheral surface of the wound electrode assembly satisfy a relation of A1 > B.

A non-aqueous electrolyte secondary battery of an aspect of the present disclosure includes a wound electrode assembly including a positive electrode, a negative electrode, and a separator in which the positive electrode and the negative electrode are wound with the separator interposed between the positive electrode and the negative electrode, a non-aqueous electrolyte, and a battery case housing the wound electrode assembly and the non-aqueous electrolyte, and a nitrogen element concentration A2 derived from an isocyanate group-containing compound in an inner wall of the battery case and a nitrogen element concentration B derived from an isocyanate group-containing compound in an inner region inside an outermost peripheral surface of the wound electrode assembly satisfy a relation of A2 > B.

A method for manufacturing a non-aqueous electrolyte secondary battery of an aspect of the present disclosure includes the steps of applying an isocyanate group-containing compound to an outermost peripheral surface of a wound electrode assembly in which a positive electrode and a negative electrode are wound with a separator interposed between the positive electrode and the negative electrode and housing the wound electrode assembly to which the isocyanate group-containing compound is applied and a non-aqueous electrolyte in a battery case, and the isocyanate group-containing compound is a compound represented by the chemical formula 1: X—N═C═O or the chemical formula 2: O═C═N—X—N═C═O wherein X represents a Cl to C12 aliphatic hydrocarbon group optionally having a heteroatom, or a C6 to C20 aromatic hydrocarbon group optionally having a heteroatom.

A method for manufacturing a non-aqueous electrolyte secondary battery of an aspect of the present disclosure includes the steps of applying an isocyanate group-containing compound to an inner wall of a battery case and housing a wound electrode assembly in which a positive electrode and a negative electrode are wound with a separator interposed between the positive electrode and the negative electrode and a non-aqueous electrolyte in the battery case to which the isocyanate group-containing compound is applied, and the isocyanate group-containing compound is a compound represented by the chemical formula 1: X—N═C═O or the chemical formula 2: O═C═N—X—N—C═O wherein X represents a C1 to C12 aliphatic hydrocarbon group optionally having a heteroatom, or a C6 to C20 aromatic hydrocarbon group optionally having a heteroatom.

### Advantageous Effects of Invention

According to an aspect of the present disclosure, it is possible to provide a non-aqueous electrolyte secondary battery in which an increase in the initial resistance can be suppressed in the case of adding an isocyanate group-containing compound to a non-aqueous electrolyte, and to provide a method for manufacturing the non-aqueous electrolyte secondary battery.

### BRIEF DESCRIPTION OF DRAWINGS

FIG. 1 is a perspective view illustrating an appearance of a non-aqueous electrolyte secondary battery according to an embodiment.

FIG. 2 is a sectional view of the non-aqueous electrolyte secondary battery taken along the line L1-L1 in FIG. 1.

### DESCRIPTTOIN OF EMBODIMENTS

Hereinafter, an example of a non-aqueous electrolyte secondary battery of an aspect of the present disclosure will be described. The drawings referred to in the following description of embodiments are schematically shown, and the dimensional ratios and the like of the components drawn in the drawings may be different from real ones.

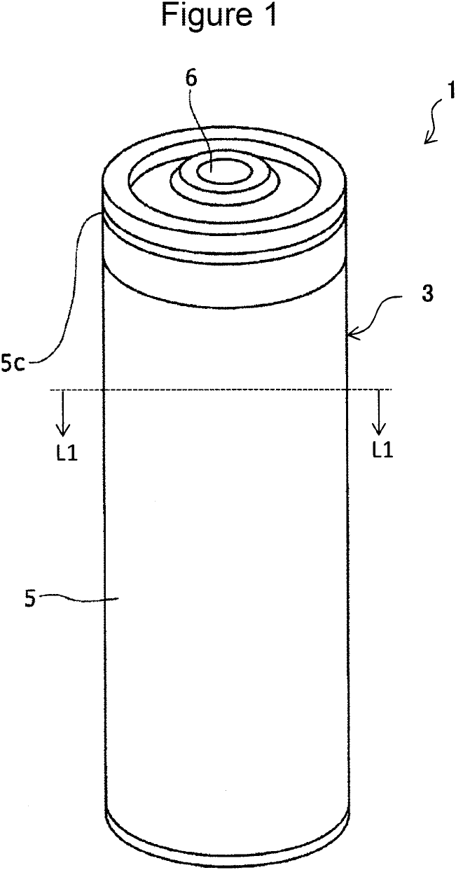

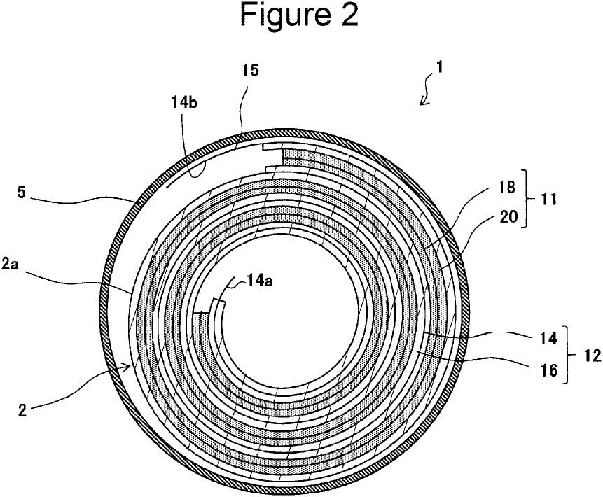

FIG. 1 is a perspective view illustrating an appearance of a non-aqueous electrolyte secondary battery according to an embodiment. FIG. 2 is a sectional view of the non-aqueous electrolyte secondary battery taken along the line L1-L1 in FIG. 1.

A non-aqueous electrolyte secondary battery 1 according to the present embodiment includes an electrode assembly 2, a non-aqueous electrolyte (not illustrated), and a battery case 3.

The battery case 3 houses the electrode assembly 2, the non-aqueous electrolyte, and the like, and includes, for example, a case body 5 having an opening, and a sealing assembly 6 sealing the opening of the case body 5. The case body 5 is, for example, a bottomed cylindrical metallic exterior housing can, and has an upper part in which a groove 5c is formed that protrudes inward along the circumferential direction. The sealing assembly 6 is supported by the groove 5c, and seals the opening of the case body 5. In order to ensure the sealability inside the battery, a gasket is desirably provided between the case body 5 and the sealing assembly 6.

The electrode assembly 2 illustrated in FIG. 2 is a wound electrode assembly in which a positive electrode 11 and a negative electrode 12 are wound with a separator interposed therebetween (hereinafter, referred to as a wound electrode assembly 2). However, FIG. 2 does not illustrate a separator disposed between the positive electrode 11 and the negative electrode 12. FIG. 2 illustrates the wound electrode assembly 2 having a cylindrical shape, but the shape of the wound electrode assembly 2 is not limited to a cylindrical shape, and may be a flat shape or the like.

The negative electrode 12 includes a negative electrode current collector 14 and a negative electrode active material layer 16 disposed on the negative electrode current collector 14. The negative electrode active material layer 16 is desirably disposed on both surfaces of the negative electrode current collector 14.

The negative electrode 12 has negative electrode current collector exposed parts 14a and 14b in which the negative electrode active material layer 16 is not disposed on the negative electrode current collector 14 and the negative electrode current collector 14 is exposed. As illustrated in FIG. 2, the negative electrode current collector exposed part 14a is located on the innermost peripheral side of the electrode assembly 2, and the negative electrode current collector exposed part 14b is located on the outermost peripheral side of the electrode assembly 2. In the negative electrode current collector exposed part 14b illustrated in FIG. 2, the negative electrode current collector 14 is exposed on the outside surface in the radial direction (outer surface) 15 of the electrode assembly 2 by the length of one or more turns from the end on the outer peripheral side of the electrode assembly 2 to form an outermost peripheral surface 2a of the electrode assembly 2. A component forming the outermost peripheral surface 2a of the electrode assembly 2 depends on the design of the electrode assembly 2. For example, in a case where the negative electrode active material layer 16 extends to the outermost periphery of the electrode assembly 2, the surface of the negative electrode active material layer 16 in the extending portion and the outer surface 15 of the negative electrode current collector exposed part 14b form the outermost peripheral surface 2a of the electrode assembly 2. In the case of a design in which the separator is on the outermost periphery of the electrode assembly 2, the outside surface in the radial direction of the electrode assembly 2 in the outermost periphery of the separator forms the outermost peripheral surface 2a of the electrode assembly 2. In the case of a design in which the positive electrode 11 is on the outermost periphery of the electrode assembly 2, the outside surface in the radial direction of the electrode assembly 2 in the outermost periphery of the positive electrode 11 forms the outermost peripheral surface 2a of the electrode assembly 2.

In the present embodiment, the outer surface 15 of the negative electrode current collector exposed part 14b is the outermost peripheral surface 2a of the electrode assembly 2, and in this case, the outer surface 15 of the negative electrode current collector exposed part 14b is desirably in contact with the inner wall of the case body 5. Thus, the case body 5 can serve as a negative electrode 12 terminal. In the present embodiment, instead of or in combination with the structure in which the outer surface 15 of the negative electrode current collector exposed part 14b is in contact with the inner wall of the case body 5, a structure may be employed in which one end of a negative electrode tab is connected to the negative electrode 12 (for example, the negative electrode current collector exposed part 14a) and the other end is connected to the case body 5 (for example, the bottom part) to make the case body 5 serve as a negative electrode terminal.

In manufacture of the non-aqueous electrolyte secondary battery, an isocyanate group-containing compound is applied to the outermost peripheral surface 2a of the electrode assembly 2, or an isocyanate group-containing compound is applied to the inner wall of the battery case 3, as described below. Therefore, in the non-aqueous electrolyte secondary battery 1 of the present embodiment, the nitrogen element concentration A1 derived from an isocyanate group-containing compound in the outermost peripheral surface 2a of the electrode assembly 2 (the outer surface 15 of the negative electrode current collector exposed part 14b in FIG. 2) and the nitrogen element concentration B derived from an isocyanate group-containing compound in the inner region inside the outermost peripheral surface 2a of the electrode assembly 2 satisfy a relation of A1 > B, and/or the nitrogen element concentration A2 derived from an isocyanate group-containing compound in the inner wall of the battery case 3 and the nitrogen element concentration B derived from an isocyanate group-containing compound in the inner region inside the outermost peripheral surface 2a of the electrode assembly 2 satisfy a relation of A2 > B. The inner region inside the outermost peripheral surface 2a of the electrode assembly 2 means a region located further in than the outermost peripheral surface 2a of the electrode assembly 2 in the radial direction of the electrode assembly 2. The term “derived from an isocyanate group-containing compound” means to be derived from an isocyanate group-containing compound itself or an isocyanate group-containing compound decomposition product produced by a charge-discharge reaction or the like. That is, in the present embodiment, an isocyanate group-containing compound and an isocyanate group-containing compound decomposition product are present in the outermost peripheral surface 2a of the electrode assembly 2 and/or the inner wall of the battery case 3 in a larger amount than in the inner region inside the outermost peripheral surface 2a of the electrode assembly 2.

An isocyanate group-containing compound added to the non-aqueous electrolyte as in the prior art decomposes during charge and discharge to form a film of the isocyanate group-containing compound decomposition product on the outermost peripheral surface 2a and in the inner region of the electrode assembly 2, and on the inner wall of the battery case 3 and the like. This film suppresses elution of a metal from the outermost peripheral surface 2a of the electrode assembly 2 and the battery case 3, and thus deterioration of charge-discharge cycle characteristics is suppressed. However, the film formed on the negative electrode active material layer or the like in the inner region of the electrode assembly 2 acts as a resistance component, and thus increases the initial resistance of the battery.

If A1, A2, and B described above satisfy the relations of A1 > B and/or A2 > B as in the non-aqueous electrolyte secondary battery of the present embodiment, a large amount of the film of an isocyanate group-containing compound decomposition product is formed on the outermost peripheral surface 2a of the electrode assembly 2 and the inner wall of the battery case 3, and a small amount of the film of an isocyanate group-containing compound decomposition product is formed in the inner region of the electrode assembly 2. In such a state, elution of a metal from the outermost peripheral surface 2a of the electrode assembly 2 and the battery case 3 is suppressed, and furthermore, a film that acts as a resistance component is less likely to be formed on the negative electrode active material layer or the like in the inner region of the electrode assembly 2, and thus an increase in the initial resistance of the battery is also suppressed.

The ratio of the nitrogen element concentration B derived from an isocyanate group-containing compound in the inner region inside the outermost peripheral surface 2a of the electrode assembly 2 to the nitrogen element concentration A1 derived from an isocyanate group-containing compound in the outermost peripheral surface 2a of the electrode assembly 2 (B/A1) is preferably 0.5 or less. The ratio of the nitrogen element concentration B derived from an isocyanate group-containing compound in the inner region inside the outermost peripheral surface 2a of the electrode assembly 2 to the nitrogen element concentration A2 derived from an isocyanate group-containing compound in the inner wall of the battery case 3 (B/A2) is preferably 0.5 or less. In a case where the above range is satisfied, deterioration of the charge-discharge cycle characteristics of the battery may be suppressed or an increase in the initial resistance of the battery may be suppressed as compared with a case where the above range is not satisfied.

The nitrogen element concentration A1 derived from an isocyanate group-containing compound in the outermost peripheral surface 2a of the electrode assembly 2 or the nitrogen element concentration A2 derived from an isocyanate group-containing compound in the inner wall of the battery case 3 is, for example, preferably in the range of 2 to 20, and more preferably in the range of 2 to 10 from the viewpoint of suppressing deterioration of the charge-discharge cycle characteristics of the battery. The nitrogen element concentration B derived from an isocyanate group-containing compound in the inner region inside the outermost peripheral surface 2a of the electrode assembly 2 is, for example, preferably 1 atom% or less and preferably zero from the viewpoint of suppressing an increase in the initial resistance of the battery. For the method of measuring the nitrogen element concentration derived from an isocyanate group-containing compound, see the section of Examples.

As the negative electrode current collector 14, for example, a foil of a metal, such as copper, that is stable in a potential range of the negative electrode 12, or a film in which the metal is disposed on its surface layer is used.

The negative electrode active material layer 16 includes, for example, a negative electrode active material, a binder, and the like.

The negative electrode active material is not particularly limited as long as it is a material capable of occluding and releasing lithium ions, and examples of the material that may be used include carbon materials such as graphite, non-graphitizable carbon, graphitizable carbon, fibrous carbon, coke, and carbon black, metals that alloy with Li, such as Si and Sn, metal compounds containing Si, Sn, or the like, and lithium-titanium composite oxides. From the viewpoint of increasing the capacity of the battery, the negative electrode active material preferably contains, for example, a carbon material and a Si material, and the ratio of the Si compound to the total mass of the negative electrode active material is preferably 5.5 mass% or more. Examples of the Si material include SiOx (0.5 ≤ x ≤ 1.6).

Examples of the binder include fluorine-based resins, polyacrylonitrile (PAN), polyimide-based resins, acryl-based resins, polyolefin-based resins, styrene-butadiene rubber (SBR), nitrile-butadiene rubber (NBR), carboxymethyl celluloses (CMCs) and salts thereof, polyacrylic acid (PAA) and its salts (such as PAA-Na and PAA-K, that may include partially neutralized salts), and polyvinyl alcohol (PVA). These may be used singly or in combination of two or more kinds thereof.

The negative electrode 12 can be produced by, for example, preparing a negative electrode mixture slurry including a negative electrode active material, a binder, and the like, applying the negative electrode mixture slurry to the negative electrode current collector 14, drying the applied slurry to form a negative electrode active material layer 16, and rolling the negative electrode active material layer.

The positive electrode 11 includes a positive electrode current collector 18 and a positive electrode active material layer 20 disposed on the positive electrode current collector 18. The positive electrode active material layer 20 is desirably disposed on both surfaces of the positive electrode current collector 18 as illustrated in FIG. 2. Although not illustrated in the drawings, the positive electrode 11 has a positive electrode current collector exposed part in which the positive electrode active material layer 20 is not disposed on the positive electrode current collector 18 and the positive electrode current collector 18 is exposed. One end of a positive electrode tab is connected to the positive electrode current collector exposed part, and the other end is connected to the inner wall of the sealing assembly 6. Thus, the sealing assembly 6 serves as a positive electrode 11 terminal.

As the positive electrode current collector 18, a foil of a metal, such as aluminum, that is stable in a potential range of the positive electrode 11, a film in which the metal is disposed on its surface layer, or the like can be used.

The positive electrode active material layer 20 includes, for example, a positive electrode active material, a binder, a conductive agent, and the like.

Examples of the positive electrode active material include lithium-transition metal oxides containing a transition metal element such as Co, Mn, or Ni. Examples of the lithium-transition metal oxides include LiₓCoO₂, LiₓNiO₂, LiₓMnO₂, LiₓCo_{y}Ni_{1-y}O₂, LiₓCo_{y}M_{1-y}O₂, LiₓNi_{1-y}M_{y}O₂, LiₓMn₂O₄, LiₓMn_{2-y}M_{y}O₄, LiMPO₄, and Li₂MPO₄F (M: at least one of Na, Mg, Sc, Y, Mn, Fe, Co, Ni, Cu, Zn, Al, Cr, Pb, Sb, or B, 0 < x ≤ 1.2, 0 < y ≤ 0.9, 2.0 ≤ z ≤ 2.3). These may be used singly or in combination of two or more kinds thereof. The positive electrode active material preferably includes a lithium-nickel composite oxide such as LiₓNiO₂, LiₓCo_{y}Ni_{1-y}O₂, or LiₓNi_{1-y}M_{y}O_{z} (M; at least one of Na, Mg, Sc, Y, Mn, Fe, Co, Ni, Cu, Zn, Al, Cr, Pb, Sb, or B, 0 < x ≤ 1.2, 0 < y ≤ 0.9, 2.0 ≤ z ≤ 2.3) from the viewpoint of being able to increase the capacity of the battery.

Examples of the conductive agent include carbon-based particles such as carbon black (CB), acetylene black (AB), Ketjenblack, and graphite. These may be used singly or in combination of two or more kinds thereof.

Examples of the binder include fluorine-based resins such as polytetrafluoroethylene (PTFE) and polyvinylidene fluoride (PVdF), polyacrylonitrile (PAN), polyimide-based resins, acryl-based resins, and polyolefin-based resins. These may be used singly or in combination of two or more kinds thereof.

The positive electrode 11 can be produced by, for example, applying a positive electrode mixture slurry including a positive electrode active material, a binder, a conductive agent, and the like to the positive electrode current collector 18, drying the applied slurry to form a positive electrode active material layer 20, and then rolling the positive electrode active material layer 20.

As the separator, for example, a porous sheet having an ion permeation property and an insulating property is used. Specific examples of the porous sheet include fine porous thin films, woven fabrics, and nonwoven fabrics. As a material of the separator, olefin-based resins such as polyethylene and polypropylene, cellulose, and the like are suitable. The separator may be a stacked body having a cellulose fiber layer and a thermoplastic resin fiber layer such as an olefin-based resin. The separator may be a multilayer separator including a polyethylene layer and a polypropylene layer, and a separator may be used that has a surface to which a material such as an aramid-based resin or a ceramic is applied.

The non-aqueous electrolyte includes an electrolyte salt and a non-aqueous solvent that dissolves the electrolyte salt. The electrolyte salt is preferably a lithium salt. Examples of the lithium salt include LiBF₄, LiClO₄, LiPF₆, LiA₈F₆, LiSbF₆, LiAlCl₄, LiSCN, LiCF₃SO₃, LiCF₃CO₂, Li(P(C₂O₄)F₄), LiPF₆₋ₓ(CₙF₂ₙ₊₁)ₓ (1 < x < 6, n is 1 or 2), LiB₁₀Cl₁₀, LiCl, LiBr, LiI, chloroborane lithitun, lower aliphatic lithium carboxylates, and borates such as Li₂B₄O₇ and Li(B(C₂O₄)F₂), and imide salts such as LiN(SO₂CF₃)₂ and LiN(C₁F₂₁₊₁SO₂)(CₘF₂ₘ₊₁SO₂) {1 and m are integers of 0 or more}. These lithium salts may be used singly or in combination of two or more kinds thereof. Among these lithium salts, LiPF₆ is preferably used from the viewpoint of ion conductivity, electrochemical stability, and the like. The concentration of the lithium salt is preferably 0.8 to 1.8 mol in 1 L of the non-aqueous solvent.

Examples of a solvent that can be used as the non-aqueous solvent include esters, ethers, nitriles such as acetonitrile, amides such as dimethylformamide, and mixed solvents of two or more thereof. The non-aqueous solvent may contain a halogen-substituted solvent in which at least a part of hydrogen in a solvent described above is substituted with a halogen atom such as fluorine.

Examples of the esters include cyclic carbonic acid esters such as ethylene carbonate (EC), propylene carbonate (PC), and butylene carbonate, chain carbonic acid esters such as dimethyl carbonate (DMC), ethyl methyl carbonate (EMC), diethyl carbonate (DEC), methyl propyl carbonate, ethyl propyl carbonate, and methyl isopropyl carbonate, cyclic carboxylic acid esters such as γ-butyrolactone and γ-valerolactone, and chain carboxylic acid esters such as methyl acetate, ethyl acetate, propyl acetate, methyl propionate (MP), and ethyl propionate.

Examples of the ethers include cyclic ethers such as 1,3-dioxolane, 4-methyl-1,3-dioxolane, tetrahydrofuran, 2-methyltetrahydrofuran, propylene oxide, 1,2-butylene oxide, 1,3-dioxane, 1,4-dioxane, 1,3,5-trioxane, furan, 2-methylfuran, 1,8-cineol, and crown ethers, and chain ethers such as 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

As the halogen-substituted solvent, an ester is preferably used such as a fluorinated cyclic carbonic acid ester such as fluoroethylene carbonate (FEC), a fluorinated chain carbonic acid ester, or a fluorinated chain carboxylic acid ester such as methyl fluoropropionate (FMP).

The method for manufacturing a non-aqueous electrolyte secondary battery according to the present embodiment includes the steps of applying an isocyanate group-containing compound to an outennost peripheral surface 2a of a wound electrode assembly 2 (an outer surface 15 of a negative electrode current collector exposed part 14b in FIG. 2) in which a positive electrode 11 and a negative electrode 12 are wound with a separator interposed therebetween, and housing the wound electrode assembly 2 to which the isocyanate group-containing compound is applied and a non-aqueous electrolyte in a battery case 3. The method for manufacturing of the present embodiment may include a step of applying an isocyanate group-containing compound to an inner wall of the battery case 3 before housing the wound electrode assembly 2 to which the isocyanate group-containing compound is applied and the non-aqueous electrolyte in the battery case 3. With the method for manufacturing of the present embodiment, a non-aqueous electrolyte secondary battery is obtained in which the nitrogen element concentration A1 derived from the isocyanate group-containing compound in the outermost peripheral surface 2a of the wound electrode assembly 2 and the nitrogen element concentration B derived from the isocyanate group-containing compound in the inner region inside the outermost peripheral surface 2a of the wound electrode assembly 2 satisfy a relation of A1 > B.

The method for manufacturing a non-aqueous electrolyte secondary battery according to the present embodiment includes the steps of applying an isocyanate group-containing compound to an inner wall of a battery case 3, and housing a wound electrode assembly 2 in which a positive electrode 11 and a negative electrode 12 are wound with a separator interposed therebetween and a non-aqueous electrolyte in the battery case 3 to which the isocyanate group-containing compound is applied. The method for manufacturing of the present embodiment may include a step of applying an isocyanate group-containing compound to an outermost peripheral surface 2a of the wound electrode assembly 2 (an outer surface 15 of a negative electrode current collector exposed part 14b in FIG. 2) before housing the wound electrode assembly 2 and the non-aqueous electrolyte in the battery case 3 to which the isocyanate group-containing compound is applied. With the method for manufacturing of the present embodiment, a non-aqueous electrolyte secondary battery is obtained in which the nitrogen element concentration A2 derived from the isocyanate group-containing compound in the inner wall of the battery case 3 and the nitrogen element concentration B derived from the isocyanate group-containing compound in the inner region inside the outermost peripheral surface 2a of the wound electrode assembly 2 satisfy a relation of A2 > B.

In the method for manufacturing described above, it is preferable that an isocyanate group-containing compound is not applied to the inner region inside the outermost peripheral surface 2a of the wound electrode assembly 2. However, in a case where an isocyanate group-containing compound is applied to the inner region inside the outermost peripheral surface 2a of the wound electrode assembly 2, the isocyanate group-containing compound is preferably applied in a smaller amount than an isocyanate group-containing compound to be applied to the outermost peripheral surface 2a of the wound electrode assembly 2.

In the method for manufacturing described above, when an isocyanate group-containing compound is applied to the inner wall of the battery case 3, the isocyanate group-containing compound may be applied to both the inner wall of the case body 5 and the inner wall of the sealing assembly 6, but the isocyanate group-containing compound is preferably applied to at least the inner wall of the case body 5. This is because a metal is easily eluted from the case body 5 in contact with the non-aqueous electrolyte.

The diisocyanate compound used in the method for manufacturing described above is not particularly limited as long as it is a compound having at least one isocyanate group in one molecule, but for example, preferably includes a compound represented by the chemical formula 1: X—N═C═O or the chemical formula 2: O═C═N—X—N═C═O (wherein X represents a C1 to C12 aliphatic hydrocarbon group optionally having a heteroatom, or a C6 to C20 aromatic hydrocarbon group optionally having a heteroatom) from the viewpoint of effectively suppressing deterioration of the charge-discharge cycle characteristics of the battery. The aliphatic hydrocarbon group may be a chain or cyclic group, and the chain aliphatic hydrocarbon group may be linear or branched.

The number of carbon atoms of the aliphatic hydrocarbon group is, for example, preferably in the range of 1 to 12, and more preferably in the range of 2 to 10 from the viewpoint of effectively suppressing deterioration of the charge-discharge cycle characteristics of the battery. The number of carbon atoms of the aromatic hydrocarbon group is, for example, preferably in the range of 6 to 20, and more preferably in the range of 8 to 18 from the viewpoint of effectively suppressing deterioration of the charge-discharge cycle characteristics of the battery.

Examples of the aliphatic hydrocarbon group include alkyl groups, alkenyl groups, and alkynyl groups. Examples of the aromatic hydrocarbon group include a phenyl group, a tolyl group, a benzyl group, and a phenethyl group.

The aliphatic hydrocarbon group and the aromatic hydrocarbon group may have a heteroatom substituted for a hydrogen atom or a carbon atom. The heteroatom is not particularly limited, and examples of the heteroatom include boron, silicon, nitrogen, sulfur, fluorine, chlorine, and bromine.

Examples of the diisocyanate compound represented by the above general formula include methyl isocyanate, ethyl isocyanate, propyl isocyanate, isopropyl isocyanate, butyl isocyanate, tertiary butyl isocyanate, pentyl isocyanate, hexyl isocyanate, cyclohexyl isocyanate, phenyl isocyanate, vinyl isocyanate, allyl isocyanate, ethynyl isocyanate, propynyl isocyanate, monomethylene diisocyanate, dimethylene diisocyanate, trimethylene diisocyanate, tetramethylene diisocyanate, pentamethylene diisocyanate, hexamethylene diisocyanate, heptamethylene diisocyanate, octamethylene diisocyanate, nonamethylene diisocyanate, decamethylene diisocyanate, dodecamethylene diisocyanate, 1,3-diisocyanatopropane, 1,4-diisocyanato-2-butene, 1,5-diisocyanato-2-pentene, 1,5-diisocyanato-2-methylpentane, 1,6-diisocyanato-2-hexene, 1,6-diisocyanato-3-hexene, toluene diisocyanate, xylene diisocyanate, tolylene diisocyanate, 1,2-bis(isocyanatomethyl)cyclohexane, 1,3-bis(isocyanatomethyl)cyclohexane, 1,4-bis(isocyanatomethyl)cyclohexane, 1,2-diisocyanatocyclohexane, 1,3-diisocyanatocyclohexane, 1,4-diisocyanatocyclohexane, dicyclohexylmethane-1,1′-diisocyanate, dicyclohexylmethane-2,2′-diisocyanate, dicyclohexylmethane-3,3′-diisocyanate, dicyclohexylmethane-4,4′-diisocyanate, bicyclo[2.2.1]heptane-2,5-diylbis(methyl isocyanate), and bicyclo[2.2.1]heptane-2,6-diylbis(methyl isocyanate). These may be used singly or in combination of two or more kinds thereof.

### EXAMPLES

Hereinafter, the present disclosure will be further described with reference to Examples, but the present disclosure is not limited to these Examples.

### Example

### Production of Positive Electrode

As a positive electrode active material, aluminum-containing lithium nickel cobalt oxide (LiNi_{0.88}Co_{0.09}Al_{0.03}O₂) was used. In a solvent of N-methyl-2-pyrrolidone (NMP), 100 parts by mass of the positive electrode active material, 1 part by mass of acetylene black, and 0.9 parts by mass of polyvinylidene fluoride were mixed to prepare a positive electrode mixture slurry. This slurry was applied to both surfaces of an aluminum foil having a thickness of 15 µm, the applied film was dried and then rolled with a roller to produce a positive electrode in which a positive electrode active material layer was formed on both surfaces of a positive electrode current collector. The produced positive electrode was cut into a width of 57.6 mm and a length of 679 mm and used.

### Production of Negative Electrode

As a negative electrode active material, a mixture obtained by mixing 95 parts by mass of graphite powder and 5 parts by mass of Si oxide was used. In water. 100 parts by mass of the negative electrode active material, 1 part by mass of carboxymethyl cellulose (CMC), and 1 part by mass of styrene-butadiene rubber (SBR) were dispersed to prepare a negative electrode mixture slurry. This slurry was applied to both surfaces of a copper foil having a thickness of 8 µm, the applied film was dried and then rolled with a roller to produce a negative electrode in which a negative electrode active material layer was formed on both surfaces of a negative electrode current collector. The produced negative electrode was cut into a width of 58.6 mm and a length of 662 mm and used.

### Production of Non-Aqueous Electrolyte

LiPF₆ was dissolved at a concentration of 1.4 mol/L in a non-aqueous solvent obtained by mixing ethylene carbonate (EC), methylethyl carbonate (MEC), and dimethyl carbonate (DMC) at a volume ratio of 20 : 5 : 75, and 3 mass% of vinylene carbonate (VC) was further added to produce a non-aqueous electrolyte.

### Production of Non-Aqueous Electrolyte Secondary Battery

An aluminum positive electrode lead was attached to the positive electrode current collector, a nickel-copper-nickel negative electrode lead was attached to the negative electrode current collector, and then the positive electrode and the negative electrode were wound with a polyethylene separator interposed therebetween to produce a wound electrode assembly. A negative electrode current collector exposed part as an outermost peripheral surface of the electrode assembly was coated, with a brush coating method, with hexamethylene diisocyanate (HMDI) in an amount of 0.1 mass% based on the mass of the non-aqueous electrolyte to be injected. Insulating plates were disposed above and below the wound electrode assembly, respectively, the negative electrode lead was welded to a case body, the positive electrode lead was welded to a sealing assembly, and the electrode assembly was housed in the case body. Then, the non-aqueous electrolyte was injected into the case body with a reduced pressure method, and then an opening end of the case body was crimped with a sealing assembly having a gasket to produce a non-aqueous electrolyte secondary battery. The battery capacity was 3300 mAh.

### Comparative Example 1

A non-aqueous electrolyte secondary battery was produced in the same manner as in Example except that no hexamethylene diisocyanate (HMDI) was applied to the outer peripheral surface of the wound electrode assembly.

### Comparative Example 2

A non-aqueous electrolyte secondary battery was produced in the same manner as in Example except that no hexamethylene diisocyanate (HMDI) was applied to the outer peripheral surface of the wound electrode assembly, and that 0.1 mass% of hexamethylene diisocyanate (HMDI) was added to the non-aqueous electrolyte of Example.

### Comparative Example 3

A non-aqueous electrolyte secondary battery was produced in the same manner as in Example except that no hexamethylene diisocyanate was applied to the outer peripheral surface of the wound electrode assembly, and that 0.5 mass% of hexamethylene diisocyanate was added to the non-aqueous electrolyte of Example.

### Measurement of Initial Resistance

Under an environmental temperature of 25° C., each of the non-aqueous electrolyte secondary batteries of Example and Comparative Examples was charged at a constant current of 990 mA (0.3 It) to 4.2 V and then charged at a constant voltage of 4.2 V to a final current of 66 mA to adjust the state of charge (SOC) to 100%. Then, under an environmental temperature of 25° C., the AC impedance was measured, and the resistance value at 0.02 Hz was measured as the initial resistance.

### Charge-Discharge Cycle Characteristics

Under an environmental temperature of 25° C., each of the non-aqueous electrolyte secondary batteries of Example and Comparative Examples was charged at a constant current of 990 mA (0.3 It) to 4.2 V and then charged at a constant voltage of 4.2 V to a final current of 66 mA. Next, the non-aqueous electrolyte secondary battery was discharged at a constant current of 990 mA (0.3 It) to 3.0 V. This charge-discharge cycle was regarded as 1 cycle, and 400 cycles of charge and discharge were performed. The capacity maintenance rate was measured using the following formula. A higher capacity maintenance rate indicates larger suppression of deterioration of the charge-discharge cycle characteristics.

$$\begin{matrix}\text{Capacity maintenance rate} \left(\%\right) = \\ \left(\text{discharge capacity at 400th} \text{cycle} / \text{discharge}\right) \\ \left(\text{capacity at 1st cycle}\right) \times 100\end{matrix}$$

### Measurement of Nitrogen Element Concentration Derived From Isocyanate Group-Containing Compound

Each battery after measuring the initial resistance was discharged at a constant current of 1650 mA (0.5 It) to 3.0 V under an environmental temperature of 25° C., and then each battery was disassembled in an argon gas atmosphere, the negative electrode current collector exposed part as the outermost peripheral surface of the electrode assembly was cut out, and the negative electrode on the innermost peripheral surface of the electrode assembly (winding core central part of the electrode assembly) was cut out. Each cut out product was introduced into an X-ray photoelectron analyzer (ESCA) and the nitrogen element concentration was measured in a state of being not in contact with the atmosphere. The measured nitrogen element concentration in the outermost peripheral surface of the electrode assembly was regarded as the nitrogen element concentration A derived from an isocyanate group-containing compound in the outermost peripheral surface of the electrode assembly, the nitrogen element concentration in the negative electrode on the innermost peripheral surface of the electrode assembly was regarded as the nitrogen element concentration B derived from an isocyanate group-containing compound in the inner region of the electrode assembly, and thus the nitrogen element concentration ratio (B/A) was calculated. In the measurement of the nitrogen element concentration in the inner region of the electrode assembly, in a case where the battery is known to include no isocyanate group-containing compound, the measurement point is to be set to any one point in the inner region of the electrode assembly. In a case where it is unknown whether the battery includes an isocyanate group-containing compound, the measurement point needs to be set to a plurality of points (preferably 10 to 15 points) in the inner region of the electrode assembly. Then, the maximum nitrogen element concentration in the measurement points in the inner region of the electrode assembly is used.

Table 1 summarizes the results of the initial resistance, the capacity maintenance rate, and the nitrogen element concentration ratio (B/A) of Example and Comparative Examples.

TABLE 1

| | HMDI | Initial resistance (Ω) | Capacity maintenance rate (%) | Nitrogen element concentration ratio B/A |
|---|---|---|---|---|
| Example | Applied to electrode assembly | 1.00 | 88.8 | < 0.25 |
| Comparative Example 1 | None | 1.00 | 87.9 | - |
| Comparative Example 2 | Added to electrolyte (0.1 mass%) | 1.02 | 88.1 | 1.5 |
| Comparative Example 3 | Added to electrolyte (0.5 mass%) | 1.14 | 88.8 | 1.5 |

As shown in Table 1, the initial resistance of Example 1 was equivalent to that of Comparative Example 1, and lower than those of Comparative Examples 2 to 3. The capacity maintenance rate of Example 1 was equivalent to that of Comparative Example 3. and higher than those of Comparative Examples 1 to 2. Therefore, according to Example 1, it is possible to suppress an increase in the initial resistance and to suppress deterioration of the charge-discharge cycle characteristics.

REFERENCE SIGNS LIST

| | |
|---|---|
| 1 | Non-aqueous electrolyte secondary battery |
| 2 | Electrode assembly (wound electrode assembly) |
| 2 a | Outermost peripheral surface |
| 3 | Battery case |
| 5 | Case body |
| 5 c | Groove |
| 6 | Sealing assembly |
| 11 | Positive electrode |
| 12 | Negative electrode |
| 14 | Negative electrode current collector |
| 14a, 14b | Negative electrode current collector exposed part |
| 15 | Outer surface |
| 16 | Negative electrode active material layer |
| 18 | Positive electrode current collector |
| 20 | Positive electrode active material layer |

1-7. (canceled)

8. A non-aqueous electrolyte secondary battery comprising:
a wound electrode assembly including a positive electrode, a negative electrode, and a separator, the positive electrode and the negative electrode that are wound with the separator interposed between the positive electrode and the negative electrode;
a non-aqueous electrolyte; and
a battery case housing the wound electrode assembly and the non-aqueous electrolyte, wherein
a nitrogen element concentration A1 derived from an isocyanate group-containing compound in an outermost peripheral surface of the wound electrode assembly and a nitrogen element concentration B derived from an isocyanate group-containing compound in an inner region inside the outermost peripheral surface of the wound electrode assembly satisfy a relation of A1 > B.

9. A non-aqueous electrolyte secondary battery comprising:
a wound electrode assembly including a positive electrode, a negative electrode, and a separator, the positive electrode and the negative electrode that are wound with the separator interposed between the positive electrode and the negative electrode;
a non-aqueous electrolyte; and
a battery case housing the wound electrode assembly and the non-aqueous electrolyte, wherein
a nitrogen element concentration A2 derived from an isocyanate group-containing compound in an inner wall of the battery case and a nitrogen element concentration B derived from an isocyanate group-containing compound in an inner region inside an outermost peripheral surface of the wound electrode assembly satisfy a relation of A2 > B.

10. The non-aqueous electrolyte secondary battery according to claim 8, wherein a ratio of the nitrogen element concentration B in the inner region of the wound electrode assembly to the nitrogen element concentration A1 in the outermost peripheral surface of the wound electrode assembly (B/A1) is 0.5 or less.

11. The non-aqueous electrolyte secondary battery according to claim 9, wherein a ratio of the nitrogen element concentration B in the inner region of the wound electrode assembly to the nitrogen element concentration A2 in the inner wall of the battery case (B/A2) is 0.5 or less.

12. The non-aqueous electrolyte secondary battery according to claim 8, wherein the isocyanate group-containing compound is a compound represented by the chemical formula 1: X—N═C═O or the chemical formula 2: O═C═N—X—N═C═O wherein X represents a C1 to C12 aliphatic hydrocarbon group optionally having a heteroatom, or a C6 to C20 aromatic hydrocarbon group optionally having a heteroatom.

13. The non-aqueous electrolyte secondary battery according to claim 9, wherein the isocyanate group-containing compound is a compound represented by the chemical formula 1: X—N═C═O or the chemical formula 2: O═C═N—X—N═C═O wherein X represents a C1 to C12 aliphatic hydrocarbon group optionally having a heteroatom, or a C6 to C20 aromatic hydrocarbon group optionally having a heteroatom.

14. A method for manufacturing a non-aqueous electrolyte secondary battery, the method comprising the steps of:
applying an isocyanate group-containing compound to an outermost peripheral surface of a wound electrode assembly in which a positive electrode and a negative electrode are wound with a separator interposed between the positive electrode and the negative electrode; and
housing the wound electrode assembly to which the isocyanate group-containing compound is applied and a non-aqueous electrolyte in a battery case, wherein
the isocyanate group-containing compound is a compound represented by the chemical formula 1: X—N═C═O or the chemical formula 2: O═C═N—X—N═C═O wherein X represents a C1 to C12 aliphatic hydrocarbon group optionally having a heteroatom, or a C6 to C20 aromatic hydrocarbon group optionally having a heteroatom.

15. A method for manufacturing a non-aqueous electrolyte secondary battery, the method comprising the steps of:
applying an isocyanate group-containing compound to an inner wall of a battery case; and
housing a wound electrode assembly in which a positive electrode and a negative electrode are wound with a separator interposed between the positive electrode and the negative electrode and a non-aqueous electrolyte in the battery case to which the isocyanate group-containing compound is applied, wherein
the isocyanate group-containing compound is a compound represented by the chemical formula 1: X—N═C═O or the chemical formula 2: O═C═N—X—N═C═O wherein X represents a C1 to C12 aliphatic hydrocarbon group optionally having a heteroatom, or a C6 to C20 aromatic hydrocarbon group optionally having a heteroatom.
